(19) United States
(12) Patent Application Publication
(10) Pub. No.: US 2009/0211343 A1
(43) Pub. Date: Aug. 27, 2009

(54) In-situ structuring rheometer based on chaotic advection

(76) Inventors: David Zumbrunnen, Seneca, SC (US); Graham Harrison, Arlington, VA (US)

Correspondence Address: LEIGH P. GREGORY, PO BOX 168, CLEMSON, SC, 29633-0168, US

(21) Appl. No.: 12/321,411

(22) Filed: Jan. 21, 2009

Related U.S. Application Data
(60) Provisional application No. 61/011,486, filed on Jan. 17, 2008.

(51) Int. Cl. G01N 11/10

(52) U.S. Cl. 73/54.37

(57) ABSTRACT

An in-situ structuring rheometer provides a means to develop and measure the rheological properties of structured materials such as those having various polymer blend morphologies or particle networks. Chaotic advection of liquid contained within a cavity is instilled by controlled motions of boundary surfaces and, concomitantly, forces and displacements on the boundary surfaces are measured, indicating at least one of a flow- or a structure-related property.

This application claims the benefit of prior provisional application U.S. Ser. No. 61/011,486, filed Jan. 17, 2008.

### FIELD OF THE INVENTION

The present invention relates to an in-situ structuring rheometer, a method of chaotic advection, and blends prepared thereby. Specifically, the present invention relates to rheometers which induce chaotic advection to form fine-scale structures in material ingredients of which one or more are present in a liquid or liquid-like state.

### BACKGROUND OF THE INVENTION

A rheometer is an instrument that measures shear and elongational viscosities and visco-elastic properties of materials. Rheology is the flow of fluids and deformation of solids under various kinds of stress and strain. A rheometer, therefore, measures material behavior such as yield stress, kinetic properties, complex viscosity, modulus, creep, and recovery. Traditional rheometers impart shear or elongational flows and detect, via shear or strain measurements, the various viscosities in a flow.

In the field of polymer processing, rheometers are used to assess the processing characteristics of materials to facilitate manufacturing such as by screw extrusion or injection molding. Based on the results of these tests, adjustments are made in the manufacturing process or other materials are selected that provide rheological properties deemed suitable. However, present-day rheometers have only limited ability for characterizing the rheological properties of materials that have fine-scale internal structures. Examples of such structures include polymer blends where polymer components are arranged into numerous layers having thicknesses below a few microns and nanocomposites consisting of platelets where platelets are oriented and localized within layers having thicknesses less than 200 nanometers. Such materials have important applications, such as in low permeable or toughened plastics, so an ability to measure their rheological properties can be practically important.

More recent efforts have been directed toward measurement of these properties on-line or in-line during the manufacturing process, thereby providing quicker and continuous feedback to a process controller and allowing closer control over the quality of the polymer melt. However, such on-site rheometers are merely providing information in a more timely fashion. They are not actually structuring the polymer melts.

It is generally known that two or more constituent materials can be mixed to obtain a composition in which the constituents are substantially completely dispersed so as to yield a homogeneous final composition of predefined character. Such practices may be carried out by known equipment such as screw extruders and blade blenders and yield extruded or batch compositions of generally consistent, non-alterable morphology. The properties of such compositions are thus defined almost exclusively by the compositional character of the blended material without regard to structure. That is, the dispersed individual constituents are not controlled in a manner to impart particular desired structural characteristics.

Smart blenders based on chaotic advection, which produce controlled morphological characteristics within a resulting blend, have been disclosed, for example, in U.S. Pat. Nos. 6,770,340 and 6,902,805, as well as U.S. Patent Application Publication Nos. 2005/0113503, 2004/0180204, and 2005/0265119, all of which are hereby incorporated herein by reference in their entirety. As will be appreciated, unlike mixers such as screw extruders and the like that do not have as a goal the formation of specific structures among material components, blenders based on chaotic advection operate to stretch and fold the constituents within the compositional blend to convert injected melts into multi-layers that refine progressively and can transform to a variety of derivative blend morphologies. Where an injected melt contains solid particles, networks among the particles can be formed or orientation can be imparted. Thus, by controlling the degree of blending, predefined morphological characteristics may be achieved.

### SUMMARY OF THE INVENTION

An object of the present invention is to provide a means to measure the Theological properties of structured materials whereby the structure is developed by the rheometric device. Another object of the present invention is to provide a novel in-situ structuring rheometer that allows for online monitoring of structural development in a chaotic advection process. That is, prior art smart blending studies rely on an ex post facto analysis of the blended materials to discern structure. The present invention employs rheology-based arguments, coupled with microscopy measurements (made, e.g., in-situ or once a sample has been quenched), to develop or provide protocols for quantifying structure development in an online fashion. In other words, an object of the present invention is to employ rapid feedback techniques to monitor, amend, change, finish or otherwise modify a chaotic advection process. Through an extensive series of measurements, protocols for structural development and monitoring can be established.

More particularly, in one embodiment the present invention is directed to a test cell in which chaotic advection is induced such that material ingredients in a liquid-like state contained in the test cell become structured while rheological measurements are made. Such measurements include, but are not limited to, stresses, strains and temperature. A variety of structured melts can be formed by chaotic advection. With this invention, measurements of stresses, strains and temperature and an ability to form structured melts by chaotic advection are used to discern how melt structure influences apparent viscosities. The test cell includes movable surfaces in order to induce chaotic advection within its material contents and either can be enclosed or allow for injection and discharge of materials. In a particular configuration, the test cell consists of a finite cylinder bounded by a concentric rotatable disk and an eccentric rotatable disk.

More broadly, the present invention is directed to an in-situ structuring rheometer which includes a cavity formed by fixed boundary surfaces and moving boundary surfaces, whereby chaotic advection of one or more liquid, or other deformable material, contained within the cavity is instilled by controlled motions of the moving boundary surfaces and wherein forces on the boundary surfaces are measured, such measurements indicating at least one of a flow-related and a structure-related property of the liquid. The cavity may be closed or open. The liquids may contain solid additives. Optionally, the rheometer is in communication with a controller and the controller regulates the motions of the moving boundary surfaces. Further, one or more external measuring devices may be employed and such measuring devices may be in communication with the controller. In such case, in response to the measurement taken, the controller communicates an instruction to the rheometer. Most preferably, the liquid comprises a major phase component and at least one minor phase component, and movement of the moving boundary surfaces is adjusted responsive to the simultaneously measured at least one of a flow-related and a structure-related property in order to obtain a blend having desired morphological characteristics.

More specifically the present invention is directed to an in-situ structuring rheometer capable of generating chaotic advection in liquids contained therein which includes a substantially vertical cylinder defining an inner diameter, an upper open end and a lower open end; an upper substantially circular disk removably insertable into the upper open end; a lower disk underlying the lower open end wherein the lower disk has a larger diameter than the inner diameter; an upper axle connecting the upper substantially circular disk to a rotational rheometer head; and a lower axle connecting the lower circular disk with a rotating motor.

The present invention is also directed to a method of chaotic advection which includes the steps of providing an in-situ structuring rheometer which includes a substantially vertical cylinder defining an inner diameter, an upper open end and a lower open end; an upper substantially circular disk removably insertable into the upper open end; a lower disk underlying the lower open end wherein the lower disk has a larger diameter than the inner diameter; an upper axle connecting the upper substantially circular disk to a rotational rheometer head; and a lower axle connecting the lower circular disk with a rotating motor; charging the cylinder with a mixture of liquefied composite materials; inserting the upper disk into the cylinder wherein the disk is in contact with the mixture; operating the rheometer head in a constant strain mode to rotate the upper shaft through a specific angular displacement, thereby rotating the upper disk; and measuring the torque required to maintain the specific angular displacement while chaotic mixing is ongoing. Preferably such method further includes the step of rotating the lower disk in the opposite direction of the rotation of the upper disk. Most preferably this method further includes the step of alternating the rotations of the upper disk and the lower disk, such that when the upper disk is rotating the lower disk is stationary and when the lower disk is rotating the upper disk is stationary.

### BRIEF DESCRIPTION OF THE FIGURE OF THE DRAWING

A full and enabling disclosure of the present invention, including the best mode thereof, to one of ordinary skill in the art is set forth more particularly in the remainder of the specification, including reference to the following FIGURE, and the accompanying claims.

FIG. 1 is a schematic representation of an in-situ structuring rheometer in accordance with the present invention.

### DETAILED DESCRIPTION OF THE PREFERRED EMBODIMENTS

Generally, the present invention is directed to a rheometer in which chaotic advection is induced such that material ingredients in a liquid-like state contained in the rheometer become structured while rheological measurements are made. The rheometer includes movable surfaces in order to induce chaotic advection within its material contents and can be enclosed or allow for injection and discharge of materials. In a particular configuration, the rheometer consists of a finite cylinder bounded by a concentric rotatable disk and an eccentric rotatable disk.

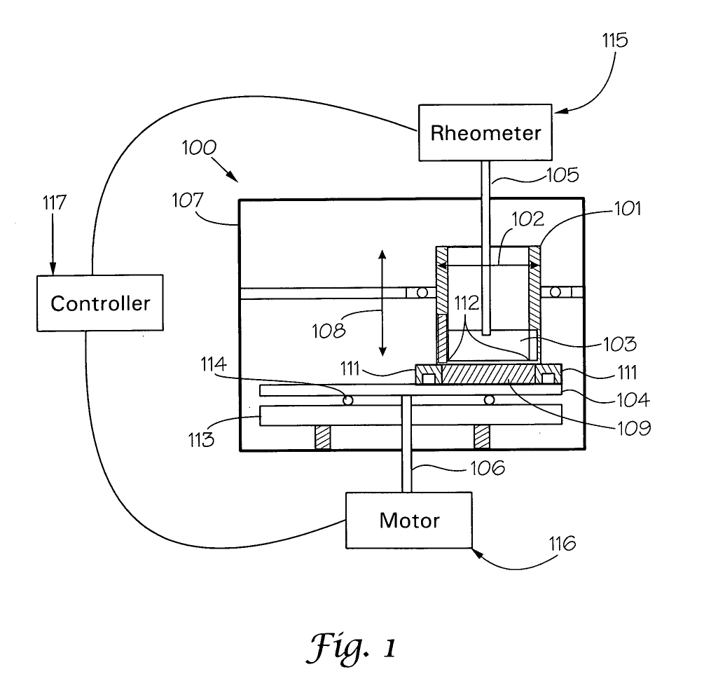

Thus, the elements of a preferred embodiment of the in-situ structuring rheometer (ISSR) in accordance with the present invention are more specifically depicted in FIG. 1, in which ISSR 100 comprises a stationary, vertical cylinder 101 with an inside diameter 102 (D), and upper disk 103 and a lower disk 104. Chaotic advection in the liquefied composite material is instilled by separately and periodically rotating each disk by a specific angular displacement via an upper shaft 105 and a lower shaft 106 that extend into an oven 107 in which the cylinder 101 is placed.

Upper shaft 105 is connected to a conventional controlled stress rheometer 115 (for example, provided by TA Instruments, model number AR2000, New Castle, Del.) or other device capable of detecting axial forces and rotational torques. For purposes of the present description and claims, the combination of upper disk 103, shaft 105 and rheometer 115 is known as a “rheometer head.”

A conventional controlled stress rheometer applies a prescribed torque to a rotating plate and then measures the rotation rate of the plate under that torque.

By contrast, in the present invention the rheometer head is operated in constant strain mode, in which a feedback loop is employed in motor controller 117 to vary the torque such that a constant rotation rate is achieved. Thus, the torque is controlled and the rotation (and therefore the characteristic shear) rate is measured in the single head element, eliminating the need for the bottom fixture typically employed in constant strain rheometers.

The vertical height (H) 108 of the ISSR is adjustable by moving the upper disk (103) into and out of the cylinder 101. The rotational axis 109 of the lower disk 104 is offset from the axis of the cylinder 110. The sealing means 111 may be inserted in the base 112 of the cylinder to prevent leakage of the liquid composite material along the lower disk 104. A leveling 113 and precision ball bearing assembly 114 ensures that the sealing means 111 maintain close contact during rotation of the lower disk 104.

In a preferred embodiment of the invention, upper disk 103 and lower disk 104 operate in blinking mode. By the term blinking mode is meant that the lower disk is stationary during the motion of the upper disk and the subsequent measurements of torque and shear rate are performed exactly as in a conventional parallel plate rotational rheometer.

According to the present invention, rheological measurements are made when the upper disk (substantially coaxial with the cylinder) is rotating, preferably only when rotating. At least three types of measurements are possible: (1) transient evolution of the torque/rate as a function of time; (2) dynamic oscillatory measurements between periods; and (3) stress relaxation experiments.

In another embodiment of the invention, the ratio of the radius of the cylinder 110 to the radium of the upper disk 103 exceeds 1.1, preferably 1.2, more preferably 1.3.

Lower disk 104 is connected through lower shaft 106 to motor 116. Motor 116 turns lower disk 104 by applying torque to lower shaft 106. In a preferred embodiment the motor is a stepper motor.

In another preferred embodiment, both rheometer 115 and motor 116 are in communication with a controller 117. The controller may be of any type known to those of ordinary skill in the art, e.g., an analog input-output device, microprocessing unit with appropriate interface, digital computer with appropriate interface, and the like.

In a highly preferred embodiment, a substantially uniform temperature within the ISSR is provided. In some cases, such a uniform temperature control may be critical to achieve the desired advection. Optionally, the temperature of the cylinder contents may be monitored by thermocouples. An oven and/or cooling device, optionally in communication with the controller, may be adapted to removably surround the cylinder 101, the upper disk 103 and the lower disk 104. Both air and nitrogen lines are provided for heating and cooling the contents of the cylinder. Further, the ISSR may be adapted to operate under substantially anhydrous or substantially oxygen-free conditions.

The cylinder 101 generally comprises a heat-resistant composition. For example, it preferably comprises metallic or metal-based components. A stainless steel cylinder may be used. The cylinder is generally unreactive to all chemicals, the composites and any other additives, adjuvants or excipients that constitute the components that undergo blending. Nonetheless, the composition of the cylinder may be selected such that during blending, the cylinder components interact with the composition and affect the blending process.

The cylinder may also be translucent, transparent, or as known to those of skill in the art, penetrable by electromagnetic radiation or light to probe the physical properties of the composition. For example, birefringence, x-ray diffraction, an acoustic method such as ultrasonic imaging, optical microscopy and the like are contemplated by the present invention.

The sealing means may be formed from components that are heat resistant. The sealing means is generally non-reactive to all chemicals, the composites or any other additives, adjuvants or excipients that constitute the components to undergo advection. Examples of sealing means include nylon and Teflon® rings that form a seal between the lower open end of the cylinder and the lower disk 104.

The cylinder also may be in communication with and/or operably linked to a controller, which turns the cylinder so that in situ structuring can be regulated. Specifically, while the measurement of the rheological properties of the advected contents may be performed by the rheometer head, the in situ rheometer of the present invention may further comprise a measuring device, optionally in communication with the controller, to measure one or more physical properties of the advected contents. For example, devices to measure birefringence, x-ray diffraction, acoustic properties, optical properties and the like are contemplated by the present invention. Such devices, after measuring the physical property, may communicate the result to the controller, and in a particularly preferred embodiment of the invention, the controller subsequently communicates with the input devices, e.g., the rheometer, the motor, and/or the oven or cooling device to change their input into the advection process to achieve a predetermined or desired result.

The preferred embodiments are further illustrated by the following Example.

### Example 1

Pellets of component materials are randomly mixed mechanically to promote initial composition uniformity. The pellet mixture is then poured into the cavity of the ISSR and a surrounding oven or heaters are energized. Once contents are in a liquid-like condition, such as subsequent to melting, and a desired temperature has been reached, chaotic advection is instilled in the cavity contents to create structure at physical scales smaller than the initial pellet size. The controller is programmed to receive signals from the rheometer to discern theological properties. If desired, rheological measurements can also be input to the controller so that structure development of the contents in the cavity is guided by in situ measurements. The controller can, for example, instruct the rheometer to operate in constant strain mode where an upper disk to the cavity is rotating and a lower disk to the cavity is stationary. The rheometer head transmits signals back to the controller and the controller records rheological measurements. The controller adjusts the activity of the rheometer, motor and oven to achieve the desired result.

While the above-described device and method are suitably used for batch-mode processing of materials, the device and method may be adapted for continuous processing of materials such as described for producing structured plastic materials with smart blending machines in US Publication No. 2005/0265119, referenced above.

Preferred embodiments of the invention have been described using specific terms and devices. The words and terms used are for illustrative purposes only. The words and terms are words and terms of description, rather than of limitation. It is to be understood that changes and variations may be made by those of ordinary skill art without departing from the spirit or scope of the invention, which is set forth in the following claims. In addition it should be understood that aspects of the various embodiments may be interchanged in whole or in part. Therefore, the spirit and scope of the appended claims should not be limited to descriptions and examples herein.

What is claimed is:

1. An in-situ structuring rheometer comprising a cavity formed by fixed boundary surfaces and moving boundary surfaces, whereby chaotic advection of liquid contained within the cavity is instilled by controlled motions of the moving boundary surfaces and wherein forces on the boundary surfaces and displacements are measured, such measurements indicating at least one of a flow-related and a structure-related property of the liquid.

2. The rheometer of claim 1 wherein the cavity comprises a closed cavity.

3. The rheometer of claim 1 wherein the cavity comprises an open cavity.

4. The rheometer of claim 1 wherein the liquid comprises at least two components.

5. The rheometer of claim 1 wherein the liquid contains solid additives.

6. The rheometer of claim 1 wherein the rheometer is in communication with a controller, the controller regulating the motions of the moving boundary surfaces.

7. The rheometer of claim 6 further comprising an external measuring device, the measuring device measuring forces on the boundary surfaces, and the measuring device in communication with the controller.

8. The rheometer of claim 7 wherein in response to the measurement taken, the controller communicates an instruction to the rheometer.

9. The rheometer of claim 1 wherein the liquid comprises a major phase component and at least one minor phase component, and wherein movement of the moving boundary surfaces is adjusted responsive to the simultaneously measured at least one of a flow-related and a structure-related property in order to obtain a blend having desired morphological characteristics.

10. An in-situ structuring rheometer capable of generating chaotic advection in liquids contained therein comprising:
a) a substantially vertical cylinder defining an inner diameter, an upper open end and a lower open end;
b) an upper substantially circular disk removably insertable into the upper open end;
c) a lower disk underlying the lower open end wherein the lower disk has a larger diameter than the inner diameter;
d) an upper axle connecting the upper substantially circular disk to a rotational rheometer head; and
e) a lower axle connecting the lower circular disk with a rotating motor.

11. A method of chaotic advection comprising:
(i) providing an in-situ structuring rheometer comprising:
a) a substantially vertical cylinder defining an inner diameter, an upper open end and a lower open end;
b) an upper substantially circular disk removably insertable into the upper open end;
c) a lower disk underlying the lower open end wherein the lower disk has a larger diameter than the inner diameter;
d) an upper axle connecting the upper substantially circular disk to a rotational rheometer head; and
e) a lower axle connecting the lower circular disk with a rotating motor;
(ii) charging the cylinder with a mixture of liquefied composite materials;
(iii) inserting the upper disk into the cylinder wherein the disk is in contact with the contents;
(iv) operating the rheometer head in a constant strain mode to rotate the upper shaft through a specific angular displacement, thereby rotating the upper disk; and
(v) measuring the torque required to maintain the specific angular displacement while chaotic mixing is ongoing.

12. The method set forth in claim 11 further including the step of rotating the lower disk in the opposite direction of the rotation of the upper disk.

13. The method set forth in claim 11 further including the step of alternating the rotations of the upper disk and the lower disk, such that when the upper disk is rotating the lower disk is stationary and when the lower disk is rotating the upper disk is stationary.
